(19) United States
(12) Patent Application Publication
(10) Pub. No.: US 2008/0062523 A1
(43) Pub. Date: Mar. 13, 2008

(54) Optical diffraction grating and method of manufacture

(75) Inventor: James Rancourt, Southbury, CT (US)

Correspondence Address: EDWARDS ANGELL PALMER & DODGE LLP;(ALL GOODRICH ENTITIES), P.O. BOX 55874, BOSTON, MA, 02205, US

(73) Assignee: Goodrich Corporation, Charlotte, NC (US)

(21) Appl. No.: 11/728,225

(22) Filed: Mar. 23, 2007

Related U.S. Application Data
(60) Provisional application No. 60/785,782, filed on Mar. 24, 2006.

(51) Int. Cl. G02B 5/18

(52) U.S. Cl. 359/572

(57) ABSTRACT

An optical device includes a substrate, a reflecting stack and optionally, a cap layer. The reflecting stack has a first plurality of optical thin film layers and a second plurality of optical thin film layers. The first plurality of optical thin film layers are carried by the substrate, and are configured and adapted to be highly reflective of light of a first predetermined wavelength incident upon the optical device at a first predetermined angle. The second plurality of optical thin film layers are carried by the substrate and are configured and adapted to be substantially antireflective of light of a second predetermined wavelength incident upon the optical device at a second predetermined angle. The second plurality of layers are interposed between individual layers of the first plurality of layers. The cap layer, if provided, is carried by the reflecting stack.

### CROSS-REFERENCE TO RELATED APPLICATIONS

This application is a non-provisional application, claiming priority to provisional U.S. patent application 60/785,782, filed Mar. 24, 2006, which is hereby incorporated by reference in its entirety.

### BACKGROUND OF THE INVENTION

1. Field of the Invention

The present invention relates to optical diffraction gratings that incorporate a plurality of dielectric layers and to methods of manufacture thereof. Particularly, the present invention is directed to such optical devices that are manufactured using photolithographic manufacturing techniques.

2. Description of Related Art

A variety of optical devices, such as diffraction gratings, are known in the art for a variety of applications. Of such devices, diffraction gratings may include metallized portions to form the grating lines. Applicant recognizes, however, that under many conditions, metal or metallized elements are not capable of withstanding extreme conditions to which some gratings may be exposed, such as, for example, to intense laser energy. Accordingly, diffraction gratings made only of materials having high melting points, such as ceramic materials or the like, may be acceptable for such applications. In such situations, the reflective component of the gratings must be constructed of non-metallic or dielectric interference stacks.

Moreover, photolithographic techniques can be utilized to create patterns in diffraction gratings made from such ceramic materials by etching grating lines in the material of the substrate, for example.

It is often preferable that diffraction gratings be highly reflective in a particular frequency band in order that they can accomplish their intended function. The reflective member under the grating, however, may be a broad band reflector.

Photolithography utilizes light, often in the UV or deep blue portion of the visible spectrum, such as at about 413 nm, in the process of manufacture. Applicant has recognized that such manufacturing techniques can result in undesirable outcomes due to reflectance from the substructure during exposure of the photoresist which can result in a reduction in the fringe definition used to generate the grating lines.

For example, FIGS. 9 and 10 respectively illustrate reflectance versus wavelength plots of existing reflecting stacks configured to be highly reflective of light incident at about a 63 degree angle of incidence and at wavelengths near about 1050 nm. It can be seen that although high reflectance is exhibited at the aforementioned design parameters, high reflectance is also seen at about a 0 degree angle of incidence and at wavelengths near about 413 nm, the parameters at which photolithographic techniques often operate. Because there is inherent high reflector behavior in this region, it is not a simple task to reduce this peak. An object of the present invention is to suppress this reflectance peak fundamentally so that it does not occur, and, just as importantly, that the treatment is robust and the improved performance is not sensitive to small variations in layer thicknesses.

It is common practice to utilize computer modeling programs for finding optimal solutions to eliminate undesired reflections in certain wavelength bands. Applied to the issue at hand, such coatings can be designed, but include a multiplicity of layers of different thicknesses with very tight thickness tolerances. There may be dozens of layers in such a conventional design, with each layer having a different prescribed thickness. Applicant recognizes, that the tolerances for the thicknesses are so small that they cannot be economically controlled with current manufacturing techniques. Additionally, the difference in each successive layer's thickness would make manufacturing such a device a difficult chore, and very susceptible to error. Accordingly, although constructions of such antireflection coatings have been attempted, to Applicant's knowledge none has had a satisfactory yield for their intended purpose. It should be noted that the manufacturing steps are highly complex and expensive and the penalty for inadequate process control is to restart the process ab initium.

Therefore, Applicant recognizes that there has been a long-felt need for optical devices, such as refraction gratings constructed via photolithographic techniques, which have the necessary properties of having low reflectance to facilitate the photolithographic manufacturing processes, which can be manufactured with existing technologies, and which are economical to manufacture. The present invention provides a solution for these continued needs in the industry.

U.S. Pat. No. 4,229,066 to James D. Rancourt and William T. Beauchamp, describes a filter that is configured and adapted to reflect infrared light while transmitting visible light. Light over a wide range of wavelengths—between 400 nm and 1100 nm—is transmitted. This application is hereby incorporated herein by reference in its entirety. Further distinctions between U.S. Pat. No. 4,229,066 and the present invention will become apparent in the below description of the present invention.

### SUMMARY OF THE INVENTION

The purpose and advantages of the present invention will be set forth in and apparent from the description that follows. Additional advantages of the invention will be realized and attained by the methods and devices particularly pointed out in the written description and claims hereof, as well as from the appended drawings.

To achieve these and other advantages and in accordance with the purpose of the invention, as embodied, the invention includes in a first aspect, an optical device that includes a substrate and a reflecting stack. The reflecting stack has a first plurality of optical thin film layers and a second plurality of optical thin film layers carried thereon. The first plurality of optical thin film layers is configured and adapted to be highly reflective of light of a first predetermined wavelength incident upon the optical device at a first predetermined angle, and the second plurality of optical thin film layers configured and adapted to be substantially antireflective of light of a second predetermined wavelength incident upon the optical device at a second predetermined angle. The second plurality of layers are interposed between individual layers of the first plurality of layers.

In accordance with this aspect of the invention, the optical device can further include a cap layer carried by the reflecting stack. The cap layer can be initially planar and can be adapted and configured to be modified in morphology. The cap layer can be adapted and configured to be etched through photolithographic means to form surface features therein. If desired, a layer below the cap layer can be provided to act as an etch stop to an etching agent of the photolithographic means. In accordance with this aspect, the surface features can be grating lines.

In accordance with the invention, the first predetermined angle can be unequal to the second predetermined angle, and the first predetermined wavelength can be unequal to the second predetermined wavelength. Also, in accordance with the invention, the optical device can be a diffraction grating.

The first plurality of layers can be adapted and configured to be highly reflective of light in the near infrared region at a wavelength of about 1053 nm, at an angle of about 63 degrees from normal incidence. The index of refraction of adjacent optical thin film layers in the reflecting stack can be selected so that the layers alternate between high index of refraction material and low index of refraction material. If desired, the reflecting stack can be configured so that it consists essentially of a plurality of optical thin film layers, which alternate between first and second indices of refraction. The high index of refraction material can be tantalum pentoxide or another suitable material, and the low index of refraction material can be silicon dioxide or another suitable material.

In accordance with the invention, the thickness of each layer of optical thin film can be selected based on the wavelength of light intended to be reflected, transmitted or absorbed by said layer of optical thin film.

The second plurality of layers can be adapted and configured to be substantially antireflective of light in the ultraviolet region at a wavelength of about 413 nm, at about a normal angle of incidence.

The first plurality of layers can be adapted and configured to be highly reflective of light in one or more of the near infrared, short wavelength infrared, mid wavelength infrared, long wavelength infrared or far infrared regions at an angle of incidence between about 45 degrees and 90 degrees from normal incidence. More specifically, if desired, the first plurality of layers can be adapted and configured to be highly reflective of light in the infrared region at a wavelength of about 1053 nm, at about a 63 degree angle of incidence.

In accordance with another aspect of the invention, a method of manufacture of an optical device is provided. The method includes the steps of providing a substrate on which to form optical thin film layers, forming a reflective stack of alternating optical thin film layers of high index of refraction material and low index of refraction material on the substrate, forming a cap layer on the reflective stack, applying a photoresist on the cap layer, exposing the photoresist to light capable of effecting a change in the photoresist to impart a pattern on the photoresist, etching the pattern into at least the cap layer, and removing any remaining photoresist from the cap layer.

Alternatively, in accordance with the invention, the optical device can be formed without the cap layer, and the photoresist can be applied directly to the reflective stack, with the pattern being etched into the reflective stack. The step of forming layers of the reflective stack can be effected by physical vapor deposition and/or sputter deposition and/or vacuum deposition by evaporative means.

In accordance with the invention, the method can further include the step of selecting an etching substance that is capable of etching the material of the cap layer or another selected layer of the optical device, which is not capable of etching at least one layer below that layer. The etching substance can be selected so that it is not capable of etching a layer immediately below the cap layer or another selected layer. Accordingly, the layer immediately below such layer acts as an etch stop.

It is to be understood that both the foregoing general description and the following detailed description are exemplary, and are intended to be non-limiting, but are intended to provide further explanation of the claimed invention.

### BRIEF DESCRIPTION OF THE DRAWINGS

The accompanying drawings, which are incorporated in and constitute part of this specification, are included to illustrate and provide a further understanding of the method and system of the invention. Together with the description, the drawings serve to explain the principles of the invention, wherein:

FIG. 1 is a side view of an example optical device constructed in accordance with the invention having a reflective stack arranged on a substrate, and a cap layer arranged on the reflective stack;

FIG. 2 is an enlarged partial view of region A of FIG. 1, illustrating relative indices of refraction of adjacent material layers in the optical device;

FIG. 3 is a side view of an optical device constructed in accordance with the invention having a substrate, a reflecting stack, a cap layer, and a photoresist layer, prior to an etching step;

FIG. 4 illustrates the optical device of FIG. 3, in which a surface feature, particularly a grating line has been etched in the cap layer;

FIG. 5 is a tabulation of respective materials and thickness values for an example embodiment of an optical device designed and constructed in accordance with the invention;

FIG. 6 is a plot of reflectance versus wavelength for an optical device constructed in accordance with the invention;

FIG. 7 is a polar plot of the reflection coefficient for the embodiment of FIG. 5 at a wavelength of 1053 nm and 63 degree angle of incidence;

FIG. 8 is a polar plot of the reflection coefficient for the embodiment of FIG. 5 at a wavelength of 413 nm and 0 degree angle of incidence;

FIG. 9 is a plot of reflectance versus wavelength for an optical device constructed in accordance with the prior art; and

FIG. 10 is another plot of reflectance versus wavelength for an optical device constructed in accordance with the prior art.

### DETAILED DESCRIPTION

Reference will now be made in detail to selected embodiments of the invention, examples of which are illustrated in the accompanying drawings, where like reference numbers refer to like elements. It should be noted that the drawings are for illustrative purposes and may not be drawn to scale.

The present invention relates to optical devices, such as diffraction gratings used to stretch and compress high-power very short duration laser pulses. Additionally, the present invention relates to improved coatings for such gratings and methods of manufacture of such gratings.

The invention, addresses a need for a coating to have a high reflectance at a first wavelength and at a first angle of incidence and low reflectance at a second wavelength and at a second angle of incidence. The reflectance properties at the first wavelength can be due to, for example, a quarter wave stack of optical thin films tuned to the first wavelength and angle of incidence. Alternatively, a symmetric stack of optical thin films, also tuned to reflect most efficiently for the first wavelength and first angle of incidence can be used.

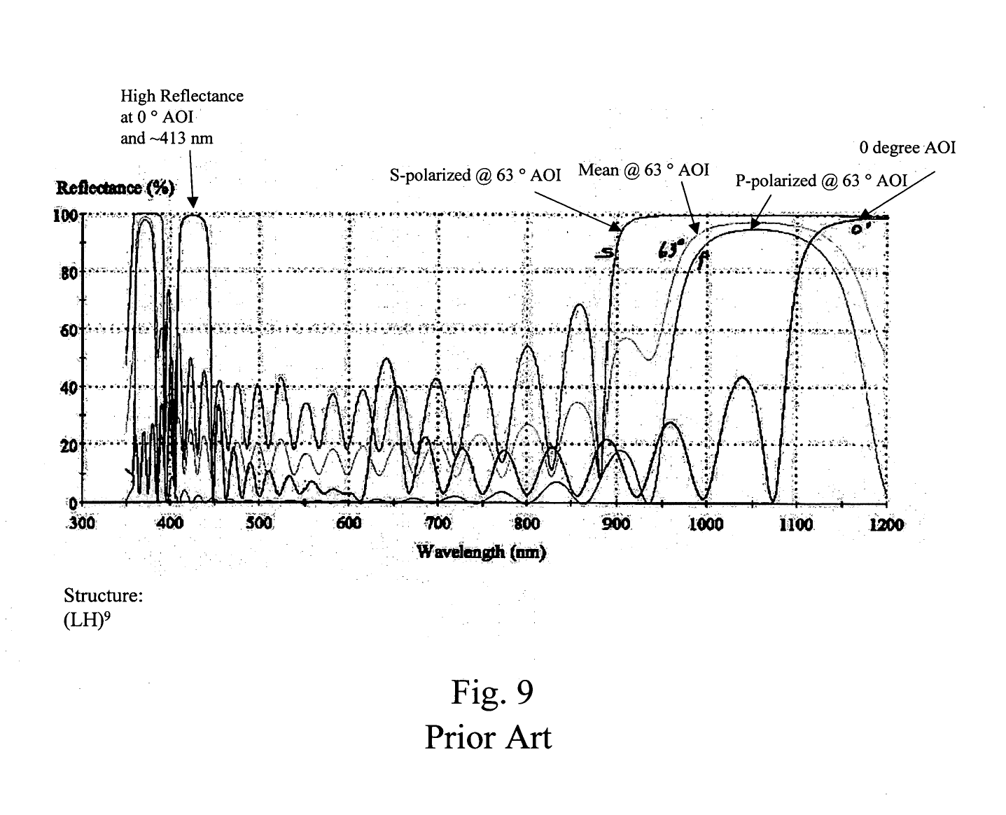

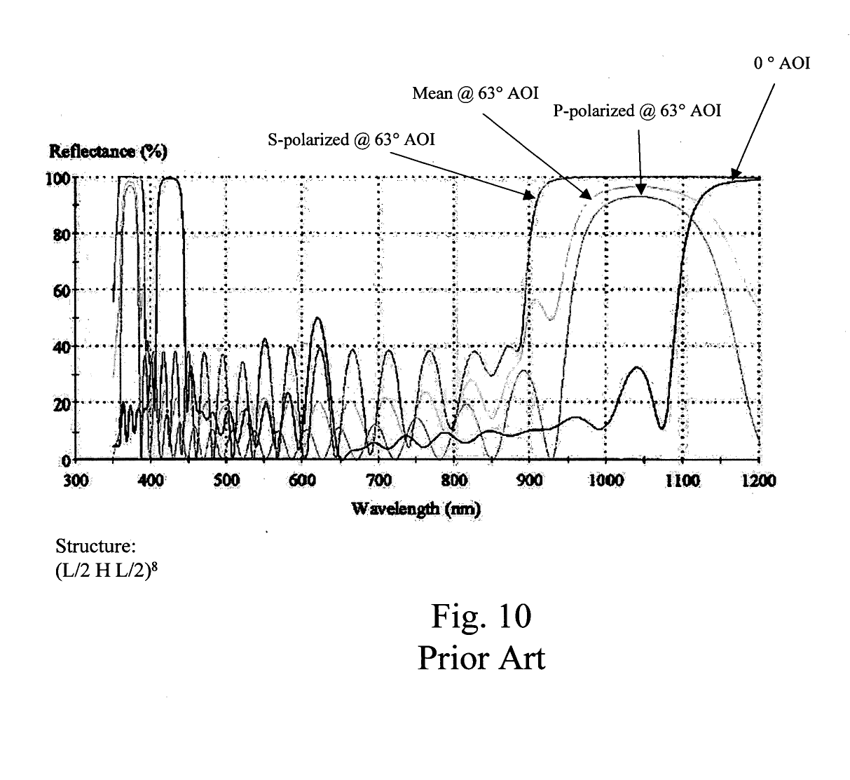

As set forth above, Applicant recognizes that such stacks can also exhibit high reflectance at other wavelengths, such as the wavelength around 413 nm, as shown in FIGS. 9 and 10, which respectively illustrate reflectance versus wavelength plots for example of existing reflecting stacks configured to be highly reflective of light at wavelengths around 1050 nm incident at about a 63 angle of incidence. Because there is inherent high reflector behavior in the 413 nm region, it is not a simple task to reduce this reflectance peak. While some techniques exist to eliminate this high order reflectance band, these techniques increase the thicknesses of the stack very significantly. Such an increase in thickness is not desirable for many reasons, including cost of the process by which the layers are deposited, decreased product yield, and increased film stress which reduces the robustness of the coating. And while an object of the present invention is to suppress this reflectance peak fundamentally so that it does not occur, it is also an object of the present invention to achieve a robust treatment such that the improved performance is not sensitive to small variations in layer thicknesses.

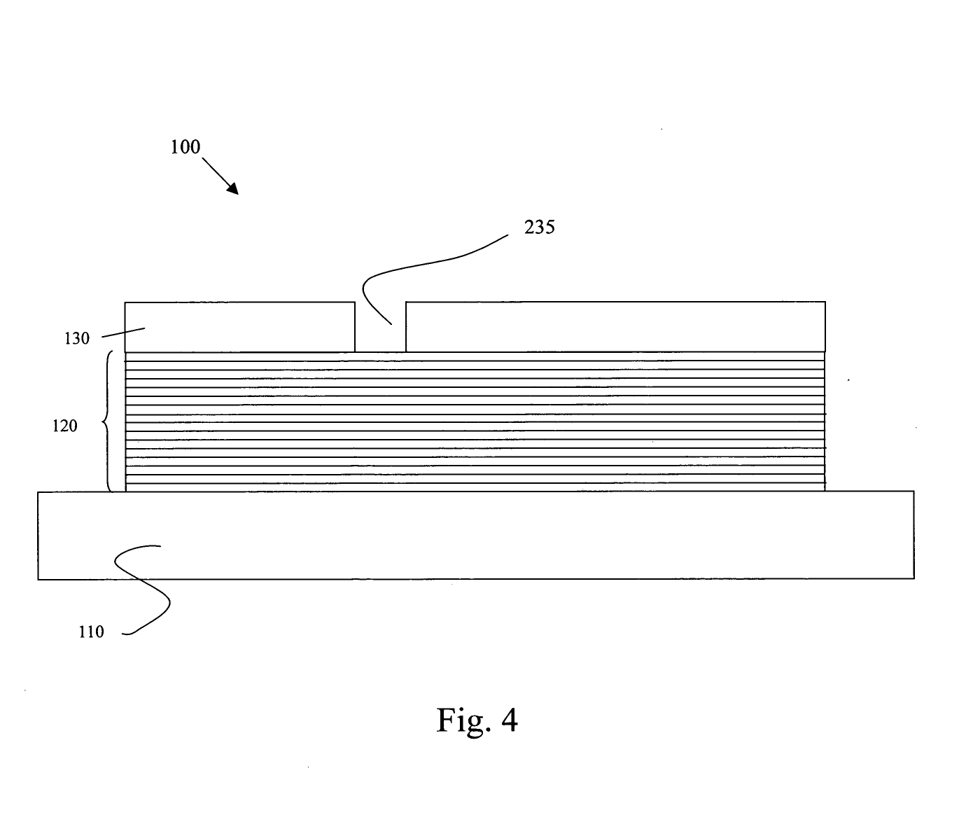

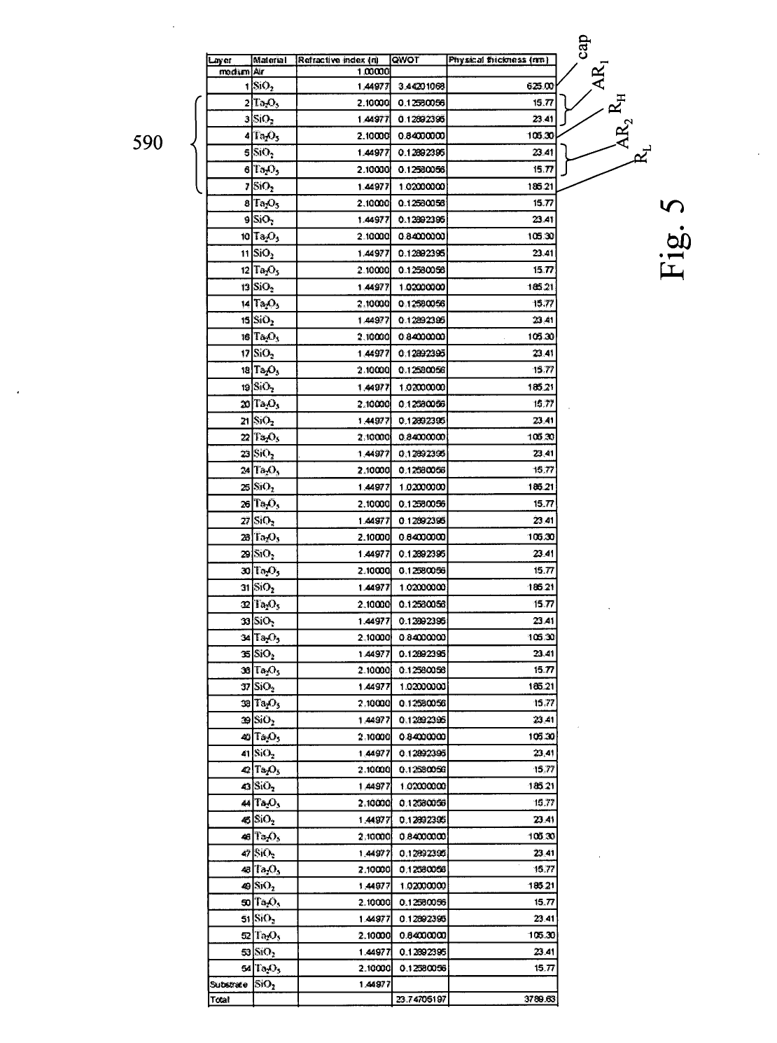

In accordance with the present invention, an antireflection (AR) structure is constructed between each layer of the high reflector stack discussed above. These AR structures are tuned for best performance at the second angle of incidence (e.g., normal incidence) and for the second wavelength (e.g. 413 nm). Between subsequent reflecting layers of the reflector stack, the order of intervening AR layers is reversed, which pattern continues throughout the reflecting stack, as can be seen in FIGS. 4 and 5, for example.

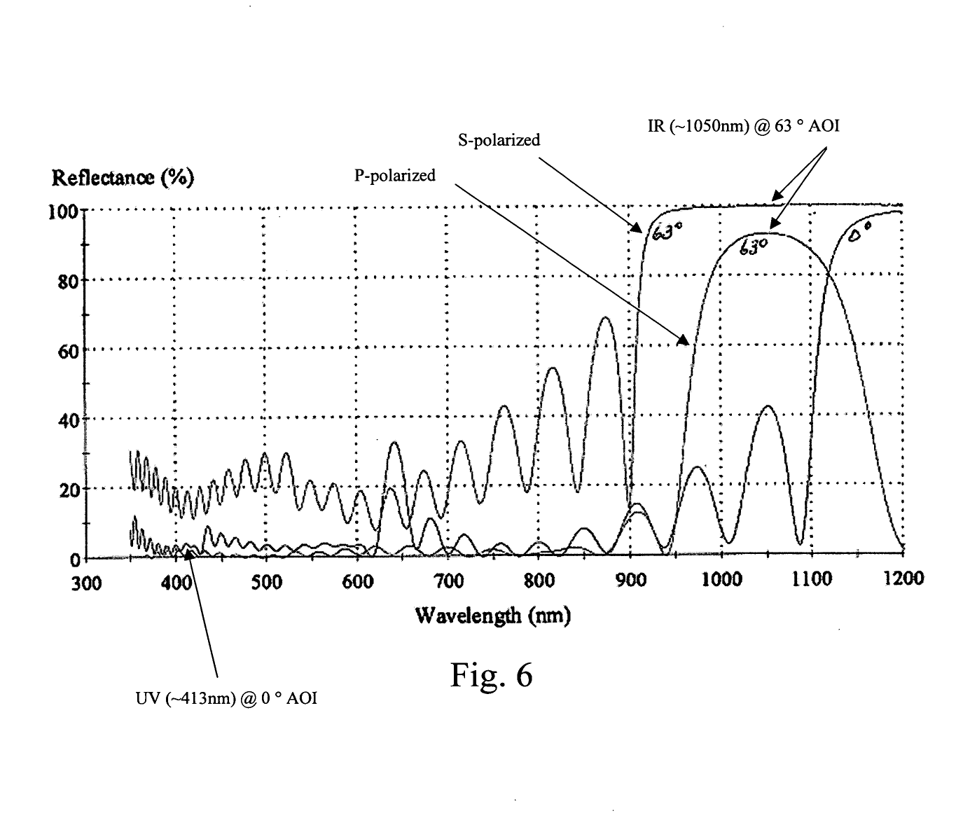

The result is that at the second angle of incidence (e.g., 0 degrees) and the second wavelength (e.g., 413 nm), the reflectance properties of the reflecting stack are essentially completely suppressed. This effect can be seen in FIG. 6, which is a plot of reflectance versus wavelength for an optical device constructed in accordance with the invention to exhibit high reflectance properties at about a 63 degree angle of incidence and wavelength of about 1050 nm, and to exhibit low reflectance at an angle of incidence of about 0 degrees and wavelength of about 413 nm.

In accordance with the invention, it should be appreciated that at the high reflectance wavelength (e.g., 1050 nm), the added AR layers are relatively thin and so do not significantly impact the high reflection properties of the reflecting stack. Moreover, although each AR structure is illustrated as having only two layers, more layers can be provided as required, including but not limited to 2, 3, 4, 5 layers, et cetera. Further, if desired, additional AR layers can be provided between the reflecting stack and the substrate and/or between the reflecting stack and the incident medium (e.g., air or the capping layer).

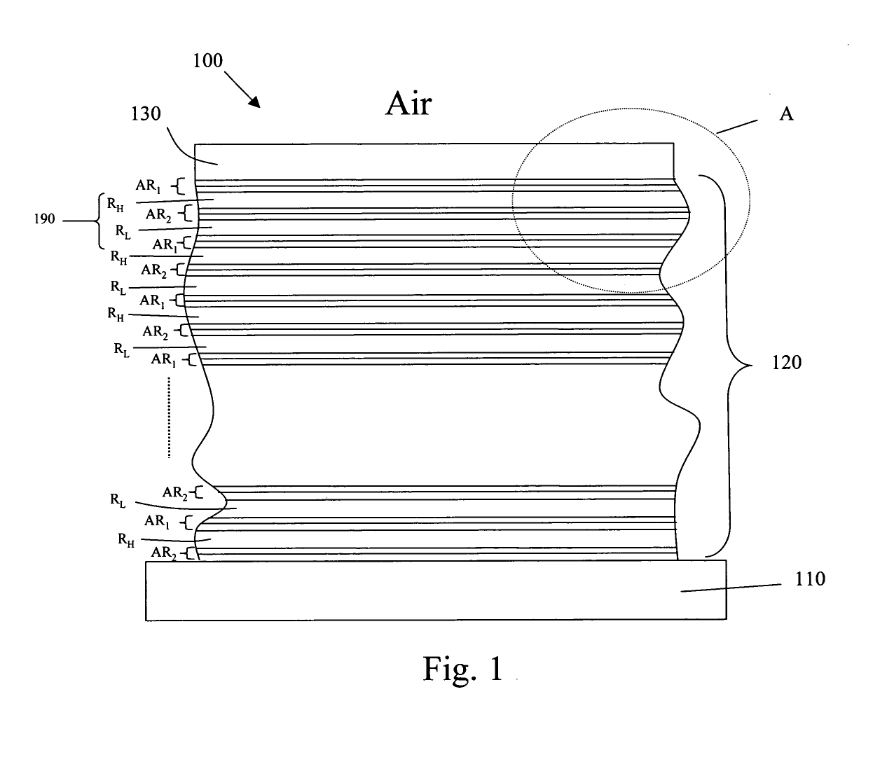

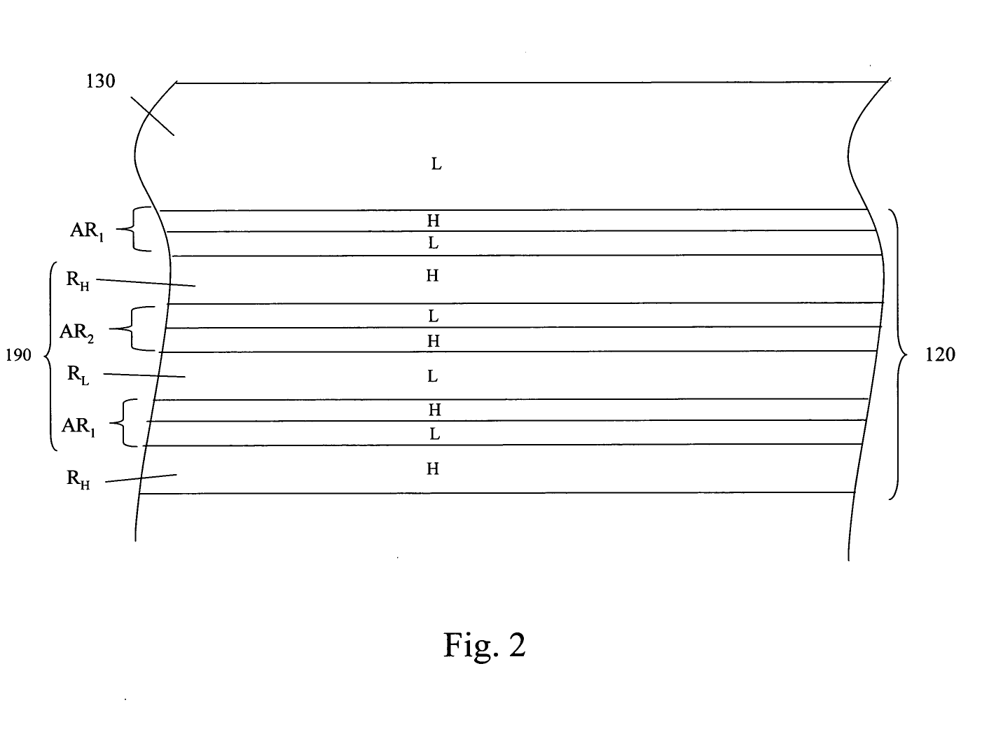

FIG. 1 illustrates an example optical device 100 constructed in accordance with the invention. A reflecting stack 120 is arranged on a substrate, and a cap layer 130 is arranged on the reflecting stack 120. The reflecting stack 120 can include a plurality of layers of material, with reflecting layers R_{H}, R_{L} being adapted and configured to reflect light of a first wavelength at a first angle of incidence, where the subscripts “H” and “L,” respectively indicate their relative indices of refraction—“high” and “low” respectively. Typically, unless otherwise noted, a high index of refraction is one higher than 1.7, and a low index of refraction is one lower than 1.7, although other values could be used, because it is the relative values which are of interest. Naturally, the indices of refraction depend on the specific materials being used, which will be discussed hereinbelow. Interspersed between each reflective layer R_{H}, R_{L}, are antireflective structures, designated generally as AR₁ and AR₂. The layers of the antireflective structures are arranged such that the reflective stack 120 overall, including reflective layers R_{H}, R_{L}, and antireflective layers AR₁ and AR₂, has alternating layers of high index of refraction material and low index of refraction material. Additionally, each antireflective structure includes high and low index of refraction layers. The order of these layers is reversed between antireflective structures designated AR₁ and those designated AR₂. This arrangement is best illustrated in FIG. 2, which is an enlarged partial view of region A in FIG. 1. FIG. 2 shows the relative indices of refraction of adjacent layers within the reflecting stack 120, including the relative index of refraction of the material of the cap layer 130.

In both FIGS. 1 and 2, an example reference frame 190 for the repetition of layers within the reflective stack 120 is illustrated by a bracket. A number of different reference frames can be selected and used to describe the pattern of the arrangement of layers within the reflective stack 120. An alternate reference frame 590 is shown in FIG. 5. Although exemplary embodiments are illustrated herein as having a particular number of repeating layer patterns (e.g., roughly eight in the embodiment of FIG. 5), it is to be understood that devices manufactured in accordance with the invention can have any number of repeating periods of layers, for example any number of periods between 1 and 100, at one-period intervals. As many periods can be utilized as are necessary to achieve the desired characteristics.

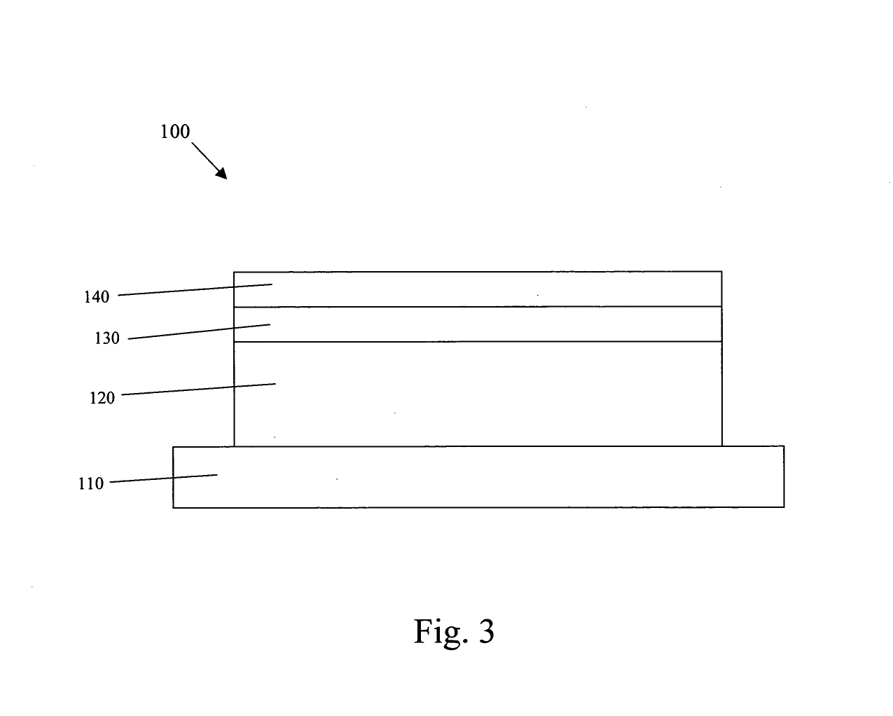

As described hereinabove, optical devices in accordance with the present invention can be manufactured using photolithographic techniques. FIG. 3 illustrates an optical device 100, including a substrate 110, reflecting stack 120, cap layer 130 and photoresist layer 140. The photoresist layer 140 is used to define a pattern on the surface of the optical device, particularly, on the cap layer 130 via an etching step.

When exposed to the ultraviolet light (or other wavelength) needed to activate the photoresist layer, the antireflective structures AR₁, AR₂ arranged between reflective layers R_{H}, R_{L} in the reflective stack prevent the ultraviolet light from reflecting excessively within layers of the optical device 100 and returning to the UV-sensitive photolithographic layer. As set forth above, such reflections would result in stray light and cause degradation of definition in the exposure of the photoresist material. However, due to the antireflective properties of the optical device 100, such internal reflections are reduced or eliminated, and thus also is degradation of definition in the exposure of the photoresist minimized or eliminated.

Preferably, the chemistry of the etching agents utilized is such that the etching agent is capable of etching the material of the cap layer, but is not capable of etching at least one layer below the cap layer, so that this impervious layer acts as an etch stop to the etching agent. Such layer can be a layer provided expressly for the purpose of acting as an etch stop, or can be a layer of the reflecting stack, made of a material or treated so as to be insusceptible to the etching agent being used.

Accordingly, the etching agent used can be selected such that the material of the cap layer 130 is etched in the exposed regions, but such that the etching ceases upon reaching a lower layer that cannot be etched by the selected etching agent. Etching agents that can be used to effect etching of, for example, a layer of silicon dioxide and not a layer of tantalum pentoxide include, but are not limited to hydrofluoric acid, or ammonium bifluoride. Other etchants are well-known to those skilled in photolithography. Depending on the materials used for the layers of the reflecting stack, etching agents can be selected accordingly.

In accordance with one aspect of the present invention, the materials which are utilized for the reflecting stack should be absorbing or transmissive in the ultraviolet range, and should be non absorbing in the infrared range. For the high index material, zinc sulphide, zinc selenide, or tantalum pentoxide can be utilized, for example. For the low index material, thorium fluoride, magnesium fluoride, sodium fluoride, strontium fluoride, fused silica, or silicon dioxide can be used, for example.

Each layer can be formed by any suitable process. Because the thickness of each layer is very small, deposition techniques preferably employed include but are not limited to physical vapor deposition or chemical vapor deposition. In a preferred embodiment, evaporation or sputter deposition is utilized to form optical thin films of optical devices in accordance with the invention.

FIG. 4 illustrates the optical device 100, in which a surface feature 235, for example a grating line, has been etched in the cap layer 130, with the etching process terminating at the boundary between the cap layer 130 and the uppermost layer of the reflecting stack 120. In FIG. 4, the photoresist, which had prevented etching of the remaining portions of the cap layer, 130 has been entirely removed following the etching step.

While selective etching based on etching chemistry interacting with the materials of the optical device is preferred in one aspect of the invention, it is to be understood that it is not required and that any conventional photolithographic technique that uses light to activate a photoresist layer can be utilized in the manufacture of devices in accordance with the invention. Moreover, it should be understood, that the present invention can be applied to many different devices, and not simply a diffraction gratings as primarily described herein.

Each layer of optical thin film provided in optical devices in accordance with the invention has a designated thickness. The quarter-wave optical thickness (QWOT) and physical thicknesses for the specific design parameters are selected based on the particular design criteria at hand, including anticipated angles of incidence and anticipated wavelengths of light incident on the optical device, and polarization of the incident light. One important advantage to the present invention, is that it is not as sensitive to departures from the nominal design thickness, as are structures manufactured in accordance with typical traditional methods that do not incorporate this invention. For example, the layer thicknesses for each reflective or AR layer can vary by as much as 25 percent about the nominal value while still achieving satisfactory performance of the optical device. Likewise, the reflective layers R_{H}, R_{L} of the reflective stack can vary about 15 percent from nominal. FIG. 5 is a tabulation of respective values for an example embodiment of an optical device designed and constructed in accordance with the invention. As can be seen, the leftmost column sequentially lists layer numbers in order, while the second column lists the material from which each respective layer is formed, with each material's respective refractive index provided in the third column. The quarter-wave optical thickness (QWOT) and physical thicknesses for the specific design parameters are provided in the remaining columns. In this embodiment, the optical device is adapted and configured to exhibit high reflectance at a first wavelength of about 1053 nm at a first angle of incidence of about 63 degrees, and to exhibit low reflectance at a second wavelength of about 413 nm at a second angle of incidence of about zero degrees.

Layer 1 corresponds to the cap layer 130 of FIGS. 1-4, and layers 2-3 correspond to the first antireflective structure “AR₁” of FIGS. 1 and 2. Layer 4 corresponds to the high index of refraction reflective layer R_{H}, while layers 5 and 6 correspond to the second antireflective structure “AR₂”. Layer 7 corresponds to the low index of refraction reflective layer R_{L} in the embodiment of FIGS. 1 and 2. Accordingly, the general arrangement of layers in accordance with the particular values of Table 5 is the same as the embodiment of FIGS. 1-4, and is therefore not illustrated separately. It should be noted that including the cap layer, only five different layer thicknesses need be formed in order to construct the reflective and antireflective layers of the embodiment of FIG. 5, and indeed in order to construct other embodiments in accordance with the invention. This is in sharp contrast with a design in accordance with typical techniques, which as described above can require dozens of different layer thicknesses in one optical device. Such variety of layer thicknesses is impractical and extraordinarily difficult, if not impossible to achieve on an economical production scale. Accordingly, the present invention makes it much simpler, or indeed possible, to produce an optical device having the required characteristics.

The behavior of the particular design parameters of the embodiment of FIG. 5 is such that at 0 degrees and 413 nm, the reflectance properties of the reflecting stack are essentially completely suppressed, while high reflectance properties are exhibited at about a 63 degree angle of incidence and a wavelength of about 1050 nm. FIG. 6, is a plot of reflectance versus wavelength for the optical device constructed in accordance with the invention having the parameters tabulated in FIG. 5. As can be seen, reflectance of light in the region of wavelengths of about 413 nm is many times lower than in the same region for exiting devices not constructed in accordance with the invention, for which reflectance versus wavelength plots are provided in FIGS. 9 and 10. For reference, the structure of the example of FIG. 9 includes a repeating layer pattern having nine repeating periods of alternating high and low-index material layers or “(LH)⁹”. The structure of the example of FIG. 10 includes a pattern of layers of (L/2 H L/2)⁸.

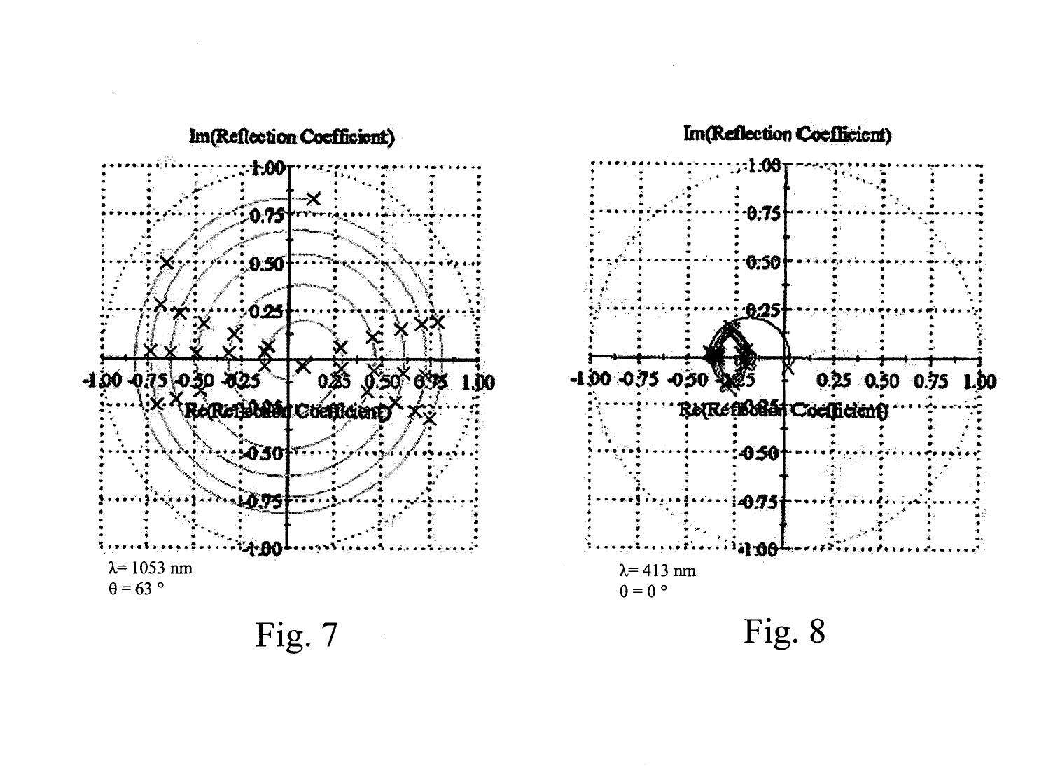

FIGS. 7 and 8 are polar plots of the amplitude reflection coefficients at 1053 nm and a 63 degree angle of incidence, with s-polarization, and at 413 nm and normal incidence, respectively, for the optical device constructed in accordance with the invention, having the parameters tabulated in FIG. 5. As can be seen, a low amplitude reflection coefficient is obtained at 413 nm (FIG. 8) while a high amplitude reflection coefficient is obtained at 1053 nm (FIG. 7). These diagrams show how the AR layers in the invention keep the amplitude reflectance localized relatively close to the origin in the new design.

In accordance with another aspect of the invention, a method of manufacture of an optical device is provided. The method includes the steps of providing a substrate on which to form optical thin film layers, forming a reflective stack of alternating layers of high index of refraction material and low index of refraction material on the substrate, forming a cap layer on the reflective stack, applying a photoresist on the cap layer, exposing the photoresist to light capable of effecting a change in the photoresist to impart a pattern on the photoresist, etching the pattern into at least the cap layer, and removing any remaining photoresist from the cap layer.

In accordance with the invention, any suitable devices can be employed to carry out the method. For example, the step of forming layers of the reflective stack can be effected by way of any suitable technique, such as by physical vapor deposition by, for example, sputtering or evaporation. One device that can be utilized to carry out such sputter deposition is a high vacuum chamber manufactured by Vacuum Process Technology, Inc. of Plymouth, Mass.

The method can further include the step of selecting an etching substance that is capable of etching material of the cap layer, but which is not capable of etching at least one layer below the cap layer. As set forth above, such selective etching substances can include hydrofluoric acid or ammonium bifluoride solution. As described hereinabove, such an etching substance can be selected such that it is not capable of etching a layer immediately below the cap layer. Accordingly, the layer immediately below the cap layer acts as an etch stop.

As desired, any suitable photolithographic technique can be used in combination with optical devices in accordance with the invention.

The methods and devices of the present invention, as described above and shown in the drawings, provide for a optical devices, such as diffraction gratings, with superior properties including ease of manufacture that have heretofore been unattainable. It will be apparent to those skilled in the art that various modifications and variations can be made in the device and method of the present invention without departing from the spirit or scope of the invention. Thus, it is intended that the present invention include such modifications and variations.

What is claimed is:

1. An optical device comprising:
a) a substrate; and
b) a reflecting stack having:
i) a first plurality of optical thin film layers carried by the substrate, configured and adapted to be highly reflective of light of a first predetermined wavelength incident upon the optical device at a first predetermined angle; and
ii) a second plurality of optical thin film layers carried by the substrate, configured and adapted to be substantially antireflective of light of a second predetermined wavelength incident upon the optical device at a second predetermined angle, the second plurality of optical thin film layers being interposed between individual layers of the first plurality of layers.

2. The optical device of claim 1, further comprising a cap layer carried by the reflecting stack.

3. The optical device of claim 2, wherein the cap layer is initially planar and is adapted and configured to be modified in morphology.

4. The optical device of claim 2, wherein the cap layer is adapted and configured to be etched through photolithographic means to form surface features therein.

5. The optical device of claim 4, wherein a layer below the cap layer acts as an etch stop to an etching agent of said photolithographic means.

6. The optical device of claim 4, wherein the surface features are grating lines.

7. The optical device of claim 1, wherein the first predetermined angle is not equal to the second predetermined angle.

8. The optical device of claim 1, wherein the light of a first predetermined wavelength is not the same wavelength as light of a second predetermined wavelength.

9. The optical device of claim 1, wherein the optical device is a diffraction grating.

10. The optical device of claim 1, wherein the first plurality of layers is adapted and configured to be highly reflective of light in the near infrared region at a wavelength of about 1053 nm, at an angle of about 63 degrees from normal incidence.

11. The optical device of claim 1, wherein the index of refraction of adjacent optical thin films in the reflecting stack alternate between high index of refraction and low index of refraction.

12. The optical device of claim 11, wherein the high index of refraction material is tantalum pentoxide.

13. The optical device of claim 11, wherein the low index of refraction material is silicon dioxide.

14. The optical device of claim 1, wherein the reflecting stack consists essentially of a plurality of optical thin film layers, which alternate between first and second indices of refraction.

15. The optical device of claim 1, wherein the thickness of each layer of optical thin film is selected based on the wavelength of light intended to be reflected, transmitted or absorbed by said layer of optical thin film.

16. The optical device of claim 1, wherein the second plurality of layers is adapted and configured to be substantially antireflective of light in the ultraviolet region at a wavelength of about 413 nm and at about a normal angle of incidence.

17. The optical device of claim 1, wherein the first plurality of layers is adapted and configured to be highly reflective of light in one or more of the near infrared, short wavelength infrared, mid wavelength infrared, long wavelength infrared or far infrared regions at an angle of incidence between about 45 degrees and 90 degrees from normal incidence.

18. The optical device of claim 17, wherein the first plurality of layers is adapted and configured to be highly reflective of light in the infrared region at a wavelength of about 1053 nm, at about a 63 degree angle of incidence.

19. A method of manufacture of an optical device, the method comprising the steps of:
a) providing a substrate on which to form optical thin film layers;
b) forming a reflective stack of alternating optical thin film layers of high index of refraction material and low index of refraction material on the substrate;
c) forming a cap layer on the reflective stack;
d) applying a photoresist to the cap layer;
e) exposing the photoresist to light capable of effecting a change in the photoresist to impart a pattern on the photoresist;
f) etching the pattern into at least the cap layer; and
g) removing any remaining photoresist from the cap layer.

20. The method of claim 19, wherein the step of forming layers of the reflective stack is effected by physical vapor deposition.

21. The method of claim 19, wherein the step of forming layers of the reflective stack is effected by sputter deposition.

22. The method of claim 19, wherein the step of forming layers of the reflective stack is effected by vacuum deposition by evaporative means.

23. The method of claim 19, further comprising the step of selecting an etching substance capable of etching the material of the cap layer, which is not capable of etching at least one layer below the cap layer.
